(19) United States
(12) Patent Application Publication
(10) Pub. No.: US 2007/0010200 A1
(43) Pub. Date: Jan. 11, 2007

(54) WIRELESS COMMUNICATION DEVICE

(75) Inventor: Yoshio KANEKO, Chiba (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 11/428,939

(22) Filed: Jul. 6, 2006

(30) Foreign Application Priority Data
Jul. 7, 2005 (JP) 2005-199127

(51) Int. Cl. H04B 7/00

(52) U.S. Cl. 455/41.2; 370/328

(57) ABSTRACT

A wireless communication device conducts communications with an another wireless communication device. The wireless communication device includes: a short-range wireless communication unit that establishes a short-range wireless communication link with the another wireless communication device, and communicates data through the short-range wireless communication link; a sonic wave transmission unit that transmits a sonic wave for detecting a position of the another wireless communication device, after the short-range wireless communication link is established; and a communication control unit that obtains a distance to the another wireless communication device from a time period between the transmission of the sonic wave and a receipt of a reply to the transmission of the sonic wave transmitted by the another wireless communication device, and controls the short-range wireless communication unit to start communicating data when the distance is equal to or less than a predetermined value.

### RELATED APPLICATION(S)

The present disclosure relates to the subject matter contained in Japanese Patent Application No. 2005-199127 filed on Jul. 7, 2005, which is incorporated herein by reference in its entirety.

### FIELD

The present invention relates to a wireless communication technology and in particular to a wireless communication device for conducting short-range wireless communications conforming to Bluetooth (registered trademark) standard.

### BACKGROUND

A short-range wireless communication device conforming to the Bluetooth standard has been widely used for communications within a range about 10 meters. The short-range wireless communication device conforming to the Bluetooth standard may enable the user to communicate with an associated party within a distance of about 30 meters depending on the communication environment. The ID of the associated party and a cryptograph at the communicating time are previously registered in short-range wireless communication devices, whereby the short-range wireless communication devices can communicate with each other in cryptographic processing. However, since the communication distance is wide, the position of the communicating party cannot be determined. The strength of a radio wave can be controlled for shortening the communication distance, but it is difficult to precisely determine the position of the communicating party because it depends on the radio wave state. When some distance is specified according to the strength of a radio wave, all are contained within the specified distance and thus communications only with a specific party positioned in the range of 2 to 3 meters cannot be conducted. Position detection using the GPS can be named as a technique of determining the position, but the detection accuracy worsens in a “valley” between tall buildings, in a building, in an underground market, etc.

On the other hand, a system is proposed wherein between a base station communication terminal having an ID code and a mobile terminal communication terminal having an ID code, the base station terminal or the mobile terminal uses at least one or more of a radio wave, an infrared ray, and an ultrasonic radar to transmit a position locating signal together with the ID of the transmitting terminal, and the base station terminal or the mobile terminal receiving it transmits the ID code of the transmitting terminal following the associated party ID code of the received radio wave for informing the associated party that the transmitting party exists nearby, thereby locating the position of the mobile terminal. (For example, refer to JP-A-2001-136562.)

However, in the related art described above, a search can be made for a nearby communication terminal to find out a terminal capable of conducting more comfortable communications, but whether or not communications are to be conducted cannot be determined based on the distance from the communicating party. Therefore, there is a demand for a technology for detecting the distance from an another wireless communication device and enable communications to be conducted only with a specific communicating party within a given distance.

### SUMMARY

According to a first aspect of the invention, there is provided a wireless communication device for conducting communications with an another wireless communication device, the wireless communication device including: a short-range wireless communication unit that establishes a short-range wireless communication link with the another wireless communication device, and communicates data through the short-range wireless communication link; a sonic wave transmission unit that transmits a sonic wave for detecting a position of the another wireless communication device, after the short-range wireless communication link is established; and a communication lo control unit that obtains a distance to the another wireless communication device from a time period between the transmission of the sonic wave and a receipt of a reply to the transmission of the sonic wave transmitted by the another wireless communication device, and controls the short-range wireless communication unit to start communicating data when the distance is equal to or less than a predetermined value.

According to a second aspect of the invention, there is provided a wireless communication device for conducting communications with an another wireless communication device, the wireless communication device including: a short-range wireless communication unit that establishes a short-range wireless communication link with the another wireless communication device, and communicates data through the short-range wireless communication link; a sonic wave reception unit that receives a sonic wave transmitted by the another wireless communication device for detecting a position of the wireless communication device, after the short-range wireless communication link is established; and a communication control unit that transmits a notification of reception of the sonic wave to the another wireless communication device through the short-range wireless communication link, and controls the short-range wireless communication unit to start communicating data when a communication start command is received from the another wireless communication device.

### BRIEF DESCRIPTION OF THE DRAWINGS

In the accompanying drawings:

FIG. 1 is a block diagram to show a configuration example of a short-range wireless communication system according to an embodiment;

FIG. 2 is a block diagram to show a configuration example of a base station and one of mobile stations according to the embodiment;

FIG. 3 is a block diagram to show a configuration example of a wireless communication device of the base station according to the embodiment;

FIG. 4 is a block diagram to show a configuration example of the mobile station according to the embodiment;

FIG. 5 is a flowchart to show an operation example of the wireless communication device of the base station according to the embodiment;

FIG. 6 is a flowchart to show an operation example of a wireless communication device of the mobile station according to the embodiment;

FIG. 7 is a block diagram to show a configuration example of a base station according to a first modified example of the embodiment;

FIG. 8 is a schematic drawing to show a configuration example of an automatic ticket gate system according to the first modified example of the embodiment;

FIG. 9 is a block diagram to show a configuration example of a mobile station according to a second modified example of the embodiment;

FIG. 10 is a block diagram to show a configuration example of a base station according to a different embodiment; and

FIG. 11 is a schematic drawing to show a configuration example of a seat reservation management system according to the different embodiment.

### DETAILED DESCRIPTION OF THE EMBODIMENT(S)

Referring now to the accompanying drawings, there are shown embodiments of the invention. The identical parts or similar parts described below with reference to the accompanying drawings are denoted by the same or similar reference numerals.

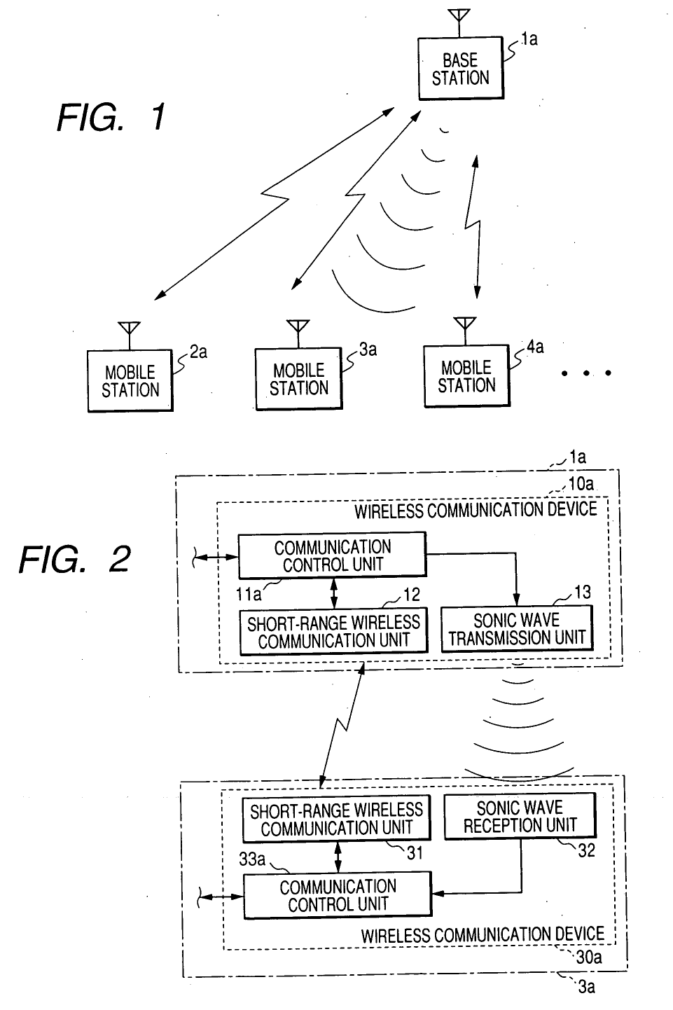

A short-range wireless communication system according to a first embodiment includes a base station 1a and a plurality of mobile stations 2a, 3a, 4a, . . . as shown in FIG. 1. As “short-range wireless communications,” short-range wireless communications conforming to the Bluetooth standard can be used. In the description to follow, it is assumed that the station 1a and each mobile station 2a, 3a, 4a, . . . conduct short-range wireless communications conforming to the Bluetooth standard with each other. The mobile stations 2a, 3a, 4a, . . . have each a similar configuration and therefore the mobile station 3a is taken as an example in the description to follow. The base station 1a includes a wireless communication device (which will be hereinafter referred to as “fixed wireless communication device”) 10a for conducting wireless communications with an another wireless communication device (mobile station 3a), as shown in FIG. 2. The mobile station 3a includes a wireless communication device (which will be hereinafter referred to as “mobile wireless communication device”) 30a for conducting wireless communications with the fixed wireless communication device 10a, as shown in FIG. 2.

The fixed wireless communication device 10a includes a short-range wireless communication unit 12 for establishing a short-range wireless communication link with the another wireless communication device (mobile wireless communication device) 30a and transmitting and receiving data using the short-range wireless communication link, a sonic wave transmission unit 13 for transmitting a sonic wave for detecting the position of the another wireless communication device (mobile wireless communication device) 30a after the short-range wireless communication link is established, and a communication control unit 11a for converting the time between transmitting the sonic wave for position detection and the another wireless communication device (mobile wireless communication device) 30a replying to transmission of the sonic wave for position detection into the distance from the another wireless communication device (mobile wireless communication device) 30a and starting transmission and reception of data when the distance is equal to or less than a predetermined value.

On the other hand, the mobile wireless communication device 30a includes a short-range wireless communication unit 31 for establishing a short-range wireless communication link with the another wireless communication device (fixed wireless communication device) 10a and transmitting and receiving data using the short-range wireless communication link, a sonic wave reception unit 32 for receiving a sonic wave for position detection transmitted by the another wireless communication device (fixed wireless communication device) 10a after the short-range wireless communication link is established, and a communication control unit 33a for sending a notification of reception of the sonic wave for position detection to the another wireless communication device (fixed wireless communication device) 10a using the short-range wireless communication link and starting transmission and reception of data when a communication start command is received from the another wireless communication device (fixed wireless communication device) 10a.

For example, ultrasonic can be used as the “sonic wave for position detection.” The ultrasonic is a high-frequency sonic wave that cannot be heard with ears of a human being. However, the frequency upper limit of the range of human hearing is about 16 kHz to 40 kHz varying from one person to another; a sonic wave having a frequency of about 16 kHz or more would be able to be used as the sonic wave for position detection. The propagation velocity of a sonic wave through the air is about 340 m/second and 1-cm propagation of a sonic wave requires 29 microseconds and thus the distance can be measured with good accuracy considering the fact that each electronic machine performs processing in about 1 to 100 nanoseconds. Since the effect of air temperature on the propagation velocity is 0.607 t (t: temperature in Celsius), when temperature change from 0 to 50 degrees in Celsius occurs, the distance can be measured with accuracy with an error of 10% or less because of 30-m variation. The fixed wireless communication device 10a can be provided with a temperature correction mechanism for decreasing the effect of air temperature fluctuation.

As ultrasonic is used, traveling of a sonic wave in a straight line improves, so that directivity is provided and the distance and the direction can be measured at the same time. Generally, directivity of about 20 degrees is provided and as the frequency is raised, the angle is further narrowed. Therefore, ultrasonic is used as the sonic wave for position detection, whereby it is made possible to determine not only the distance of the communicating party, but also the direction before data communications are started.

In a case where ultrasonic is used, the sonic wave transmission unit 13 is configured to include an oscillator (not shown) for oscillating ultrasonic, a control unit (not shown) for controlling the oscillator, and an ultrasonic speaker (not shown) for outputting the ultrasonic, for example. Likewise, the sonic wave reception unit 32 is configured to include an ultrasonic microphone (not shown) for detecting ultrasonic and converting the detected ultrasonic into an electric signal, for example.

For example, a mobile telephone, a personal handyphone system (PHS) phone, etc., can be used as each of the mobile stations 2a, 3a, 4a, . . . shown in FIG. 1. Alternatively, a personal digital assistant (PDA), a portable personal computer (portable PC), etc., having a communication function can be applied as the mobile stations 2a, 3a, 4a, . . .

To use short-range wireless communications conforming to the Bluetooth standard, each of the short-range wireless communication units 12 and 31 can use a radio wave in a 2.4-GHz band and can transmit 1M-bit data per second. The short-range wireless communication unit 12 of the fixed wireless communication device 10a operates as the master and the short-range wireless communication unit 31 of the mobile wireless communication device 30a operates as a slave. Bluetooth enables a maximum of seven slaves to be connected to one master. The master controls the frequency, the timing, etc., as the communication basis of each slave. A link establishing procedure between the master and a slave contains inquiry processing for the master to find a slave existing in the surrounding and acquiring address information, etc., and page processing of synchronizing the frequency channel with that of the slave found in the inquiry processing.

Further, the communication control unit 11a of the fixed wireless communication device 10a includes a controller 111, a storage device 112, a distance calculation circuit 113, a timer 114, and a determination circuit 115, as shown in FIG. 3. Input of the timer 114 is connected to output of the controller 111. Input of the distance calculation circuit 113 is connected to output of the timer 114. Input of the storage device 112 is connected to output of the controller 111. Input of the determination circuit 115 is connected to output of the storage device 112 and output of the distance calculation circuit 113. The controller is connected to the short-range wireless communication unit 12, the sonic wave transmission unit 13, the timer 114, and the storage device 112.

The timer 114 measures the time between transmission of a sonic wave for position detection and the another wireless communication device (mobile wireless communication device) 30a replying to transmission of the sonic wave for position detection. The distance calculation circuit 113 calculates the distance from the another wireless communication device (mobile wireless communication device) 30a in response to the time measured by the timer 114. The storage device 112 stores a predetermined value. The determination circuit 115 determines whether or not the distance calculated by the distance calculation circuit 113 is equal to or less than the predetermined value stored in the storage device 112. When the distance from the another wireless communication device (mobile wireless communication device) 30a is equal to or less than the predetermined value, the controller 111 starts transmission and reception of data. Before transmission of a sonic wave for position detection, the controller 111 transmits specification information of the frequency and the pulse width of the sonic wave for position detection to the another wireless communication device (mobile wireless communication device) 30a using a short-range wireless communication link.

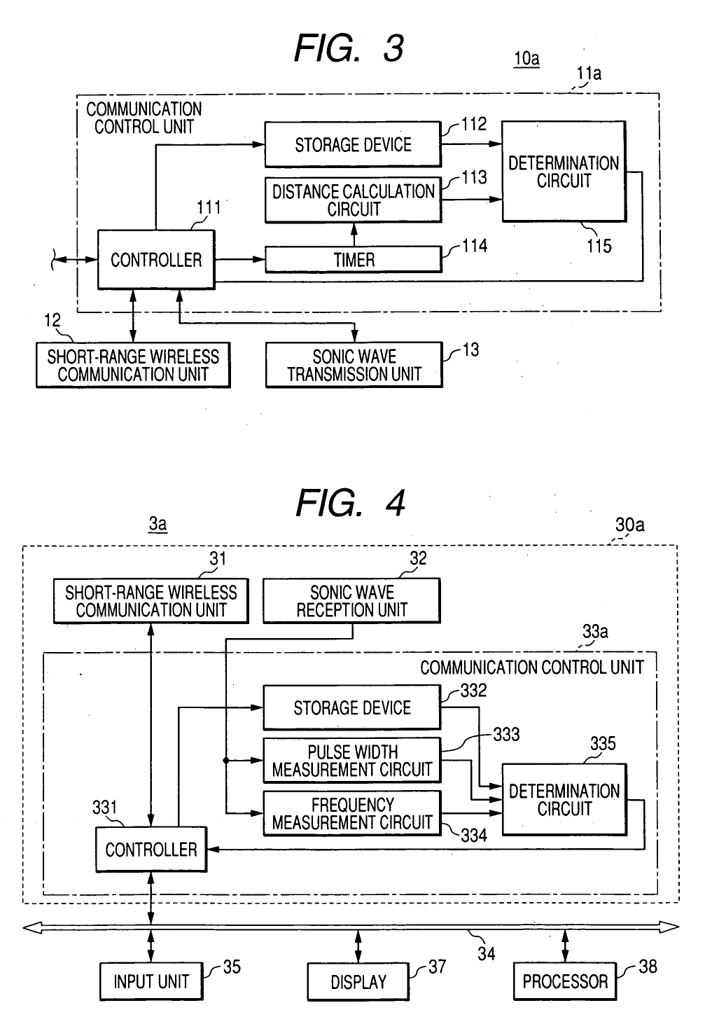

On the other hand, the mobile station 3a includes a system bus 34, an input unit 35, a display 37, a processor 38, etc., for example, in addition to the wireless communication device 30a, as shown in FIG. 4. The communication control unit 33a includes a controller 331, a storage device 332, a pulse width measurement circuit 333, a frequency measurement circuit 334, and a determination circuit 335. Input of the storage device 332 is connected to output of the controller 331. The controller 331, the input unit 35, the display 37, and the processor 38 are connected to the system bus 34. As the input unit 35, a keypad, a touch screen, a scroll button, a remote control, or the like can be used, for example. As the display 37, a liquid crystal display (LCD), a light emitting diode (LED) panel, an electroluminescence (EL) panel, or the like can be used, for example.

Further, input of the pulse width measurement circuit 333 and input of the frequency measurement circuit 334 are connected to output of the sonic wave reception unit 32. The determination circuit 335 has input connected to outputs of the storage device 332 and the frequency measurement circuit 334 and output connected to the controller 331. The storage device 332 stores the specification information received by the sonic wave reception unit 32. The pulse width measurement circuit 333 measures the pulse width of the radio wave for position detection received by the sonic wave reception unit 32. The frequency measurement circuit 334 measures the frequency of the radio wave for position detection received by the sonic wave reception unit 32. The determination circuit 335 determines whether or not the measured frequency and pulse width match the specification information stored in the storage device 332. The controller 331 sends a notification of reception of the sonic wave for position detection to the another wireless communication device (fixed wireless communication device) 10a using the short-range wireless communication link in response to the determination result of the determination circuit 335. Various protocols for conducting short-range wireless communications conforming to the Bluetooth standard are installed in each of the controllers 111 and 331 shown in FIGS. 3 and 4.

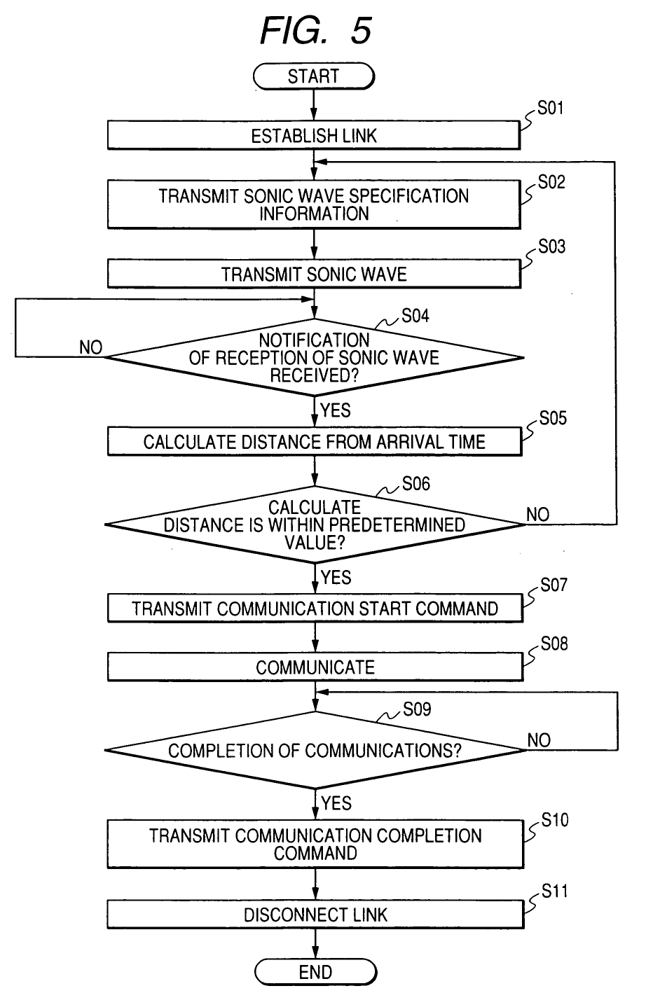

Next, the operation of the fixed wireless communication device 10a according to the embodiment will be described with reference to a flowchart of FIG. 5.

(A) At step S01, the controller 111 shown in FIG. 3 establishes a short-range wireless communication link with the mobile wireless communication device 30a shown in FIG. 4 by performing the inquiry processing and the page processing described above.

(B) At step S02, the controller 111 uses the short-range wireless communication unit 12 shown in FIG. 3 to transmit a communication request message and sonic wave specification information to the mobile wireless communication device 30a. The communication request message is, for example, a message of “negotiate communication when entered within a range of 1 m” and the specification information contains, for example, a message of “a 10-milisecond sonic wave is transmitted at 30 kHz, reply upon reception.” The transmission processing of the communication request message and that of the sonic wave specification information may be performed separately. In this case, the specification information is transmitted only if the mobile wireless communication device 30a permits the communication request message. The controller 111 stores the fact that the communication start distance is 1 m in the storage device 112 shown in FIG. 3.

(C) At step S03, the controller 111 uses the sonic wave transmission unit 13 shown in FIG. 3 to transmit a sonic wave following the specification information transmitted at step S02. The controller 111 instructs the sonic wave transmission unit 13 to transmit a 30-kHz sonic wave only for 10 milliseconds by way of example. Further, the controller 111 gives a timer operation command to the timer 114 shown in FIG. 3 after termination of transmission of the sonic wave. The timer 114 starts to measure the time.

(D) At step S04, the controller 111 determines whether or not the mobile wireless communication device 30a replies to the short-range wireless communication unit 12, namely, determines whether or not the mobile wireless communication device 30a exists within 1 m. When determined that the mobile wireless communication device 30a replies to the short-range wireless communication unit 12, the process proceeds to S05.

(E) At step S05, the controller 111 sends a stop command to the timer 114. The time measurement result of the timer 114 is sent to the distance calculation circuit 113, which then calculates the distance to the mobile wireless communication device 30a from the velocity of the sonic wave and the time of the measurement result and sends the calculation result to the determination circuit 115.

(F) At step S06, the determination circuit 115 compares between the distance condition stored in the storage device 112 and the calculated distance to determine whether or not the distance to the mobile wireless communication device 30a satisfies the distance condition, and sends the determination result to the controller 111. When determined that the distance to the mobile wireless communication device 30a satisfies the distance condition, the process proceeds to step S07. When it is not determined that the distance to the mobile wireless communication device 30a satisfies the distance condition, the process returns to step S02.

(G) At step S08, the controller 111 uses the short-range wireless communication unit 12 to communicate data with the mobile wireless communication device 30a at application level.

(H) At step S09, the controller 111 determines whether or not data communications are complete. It is determined that data communications are complete, the process proceeds to step S10.

(I) At step S10, the controller 111 instructs the short-range wireless communication unit 12 to transmit a message of “communication completion” to the mobile wireless communication device 30a.

(J) At step S11, the controller 111 disconnects the short-range wireless communication link set with the mobile wireless communication device 30a, and the processing terminates.

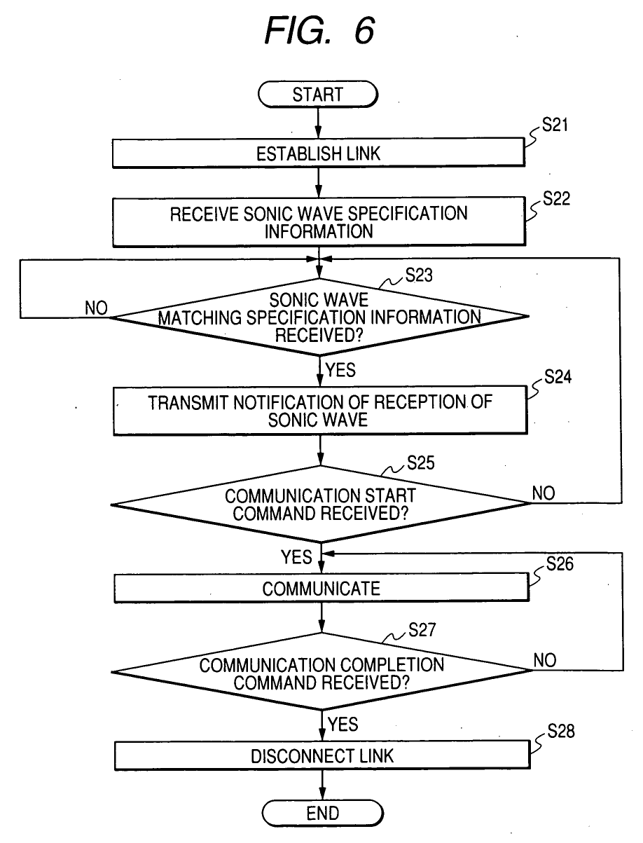

Next, the operation of the mobile wireless communication device 30a according to the embodiment will be described with reference to a flowchart of FIG. 6.

(A) At step S21, the controller 331 shown in FIG. 4 establishes a short-range wireless communication link with the fixed wireless communication device 10a shown in FIG. 3.

(B) At step S22, the short-range wireless communication unit 31 shown in FIG. 4 receives a communication request message and sonic wave specification information from the fixed wireless communication device 10a. The controller 331 uses the short-range wireless communication unit 31 to transmit a reply of “OK,” and stores the sonic wave specification information in the storage device 332. The frequency and the pulse width are stored in the storage device 332 as 30 kHz and 10 milliseconds respectively by way of example. The reception processing of the communication request message and that of the sonic wave specification information may be performed separately. In this case, the specification information is transmitted only when the controller 331 permits the communication request message. Further, when the controller 331 is programmed so as to wake up upon reception of a communication request message, power consumption can be reduced.

(C) At step S23, the controller 331 determines whether or not the sonic wave reception unit 32 receives a sonic wave matching the specification information. Specifically, the sonic wave reception unit 32 converts the received sonic wave into an electric signal and transfers the electric signal to the pulse width measurement circuit 333 and the frequency measurement circuit 334. The pulse width measurement circuit 333 measures the pulse width of the sonic wave and sends the measurement result to the determination circuit 335. The frequency measurement circuit 334 measures the frequency of the sonic wave and sends the measurement result to the determination circuit 335. The determination circuit 335 compares between the specification information stored in the storage device 332 and the measurement results of the pulse width measurement circuit 333 and the frequency measurement circuit 334 to determine whether or not the condition is satisfied. For example, whether or not the frequency and the pulse width of the sonic wave received by the sonic wave reception unit 32 are 30 kHz and 10 milliseconds is determined. When determined that the condition is satisfied, a notification of reception of the sonic wave is sent to the controller 331 and the process proceeds to step S24.

(D) At step S24, the controller 331 uses the short-range wireless communication unit 31 to transmit a notification of reception of the sonic wave.

(E) At step S25, the controller 331 determines whether or not a communication start command has been transmitted from the fixed wireless communication device 10a to the short-range wireless communication unit 31. When determined that a communication start command has been transmitted, the process proceeds to step S26. When it is not determined that a communication start command has been transmitted, the process returns to step S23.

(F) At step S26, the controller 331 uses the short-range wireless communication unit 31 to communicate data with the fixed wireless communication device 10a at application level.

(G) At step S27, the controller 331 determines whether or not a communication completion command has been transmitted from the fixed wireless communication device 10a to the short-range wireless communication unit 31. When determined that a communication completion command has been transmitted, the process proceeds to step S28. When it is not determined that a communication completion command has been transmitted, the process returns to step S26.

(H) At step S28, the controller 331 disconnects the short-range wireless communication link set with the fixed wireless communication device 10a, and the processing terminates.

Thus, according to the embodiment, the short-range wireless communication system can be constructed for conducting communications only when the distance between the fixed wireless communication device 10a and the mobile wireless communication device 30a becomes a given distance For example, communications can be made possible only when the mobile wireless communication device 30a enters the range within a 1-meter radius of the fixed wireless communication device 10a. In the description of the operation of the fixed wireless communication device 10a and the mobile wireless communication device 30a, the communication start distance (range) is a radius of 1 m by way of example. However, the distance can be set as desired like a radius of 3 m or 4 m when it is the range in which short-range wireless communications can be conducted. Further, ultrasonic is used, whereby it is made possible to set the communication start distance with the range limited, so that the position can be detected with good accuracy.

### FIRST MODIFIED EXAMPLE

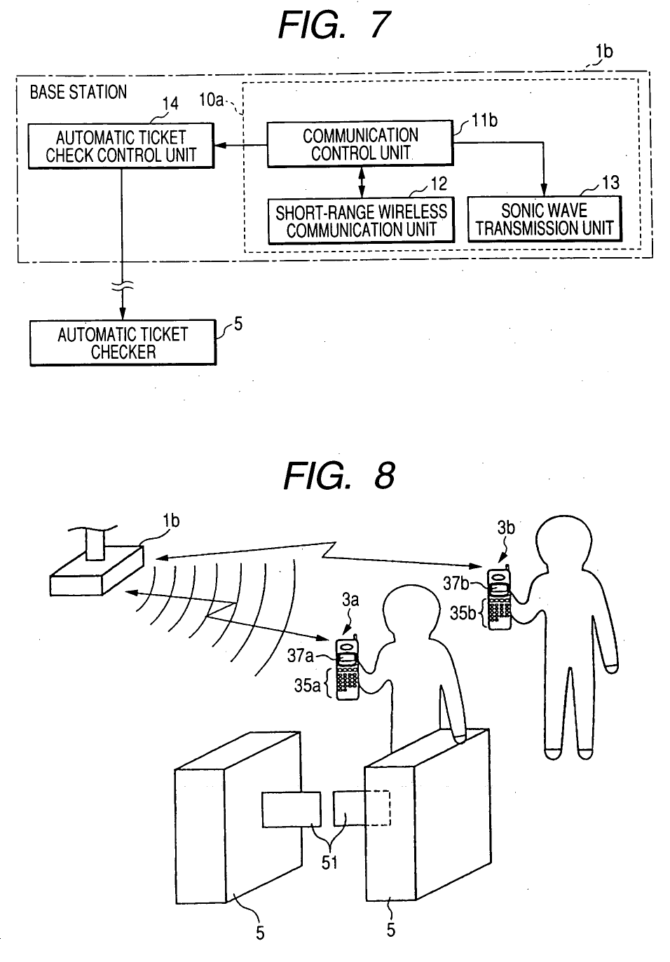

A base station 1b according to a first modified example of the embodiment is applied to an automatic ticket gate system, for example, as shown in FIG. 7. The base station 1b shown in FIG. 7 includes a ticket gate control unit 14 connected to a communication control unit 11b of a fixed wireless communication device 10a in addition to the fixed wireless communication device 10a. The ticket gate control unit 14 controls opening and closing a gate 51 through which the user of a mobile station 3a, 3b, . . . passes based on electronic ticket data transmitted from the mobile station 3a, 3b, . . . , as shown in FIG. 8. In FIG. 8, mobile telephone terminals are illustrated as the mobile stations 3a, 3b, . . . , but the mobile station is not limited to a mobile telephone terminal and any mobile terminals, such as PDAs, may be adopted.

Next, a processing procedure of the automatic ticket gate system shown in FIG. 8 will be briefly described with reference to flowcharts of FIGS. 5 and 6.

At step S01 in FIG. 5 and step S21 in FIG. 6, a short-range wireless communication link is established between each mobile station 3a, 3b, . . . and the base station 1b. Here, a message indicating that the automatic ticket gate system is operating may be displayed on a display 37a, 37b of the mobile station 3a, 3b, prompting the user to make various entries in an input unit 35a, 35b. Further, at step S02 in FIG. 5, the base station 1b transmits sonic wave specification information to each mobile station 3a, 3b, . . . and at step S03, transmits a sonic wave.

At step S22 in FIG. 6, when the mobile station 3a receives the sonic wave from the base station 1b, the mobile station 3a executes steps S23 to S25. The base station 1b executes steps S04 to S06 in FIG. 5.

When determined that the distance between the mobile station 3a and the base station 1b is equal to or less than a predetermined value, at step S07 in FIG. 5, the base station 1b transmits a communication start command to the mobile station 3a. When the mobile station 3a receives the communication start command at step S25 in FIG. 6, at step S26, the mobile station 3a transmits and receives electronic ticket data to and from the base station 1b and performs determination processing. The base station 1b is opens the gate 51 of an automatic ticket checker 5 in response to the determination result and the short-range wireless communication link between the mobile station 3a and the base station 1b is disconnected.

Thus, according to the first modified example of the embodiment, the base station 1b can detect the mobile station 3a nearest to the automatic ticket checker 5 among the mobile stations 3a, 3b . . . , can transmit and receive electronic ticket data at an appropriate distance, and can control opening and closing the gate 51 of the automatic ticket checker 5.

### SECOND MODIFIED EXAMPLE

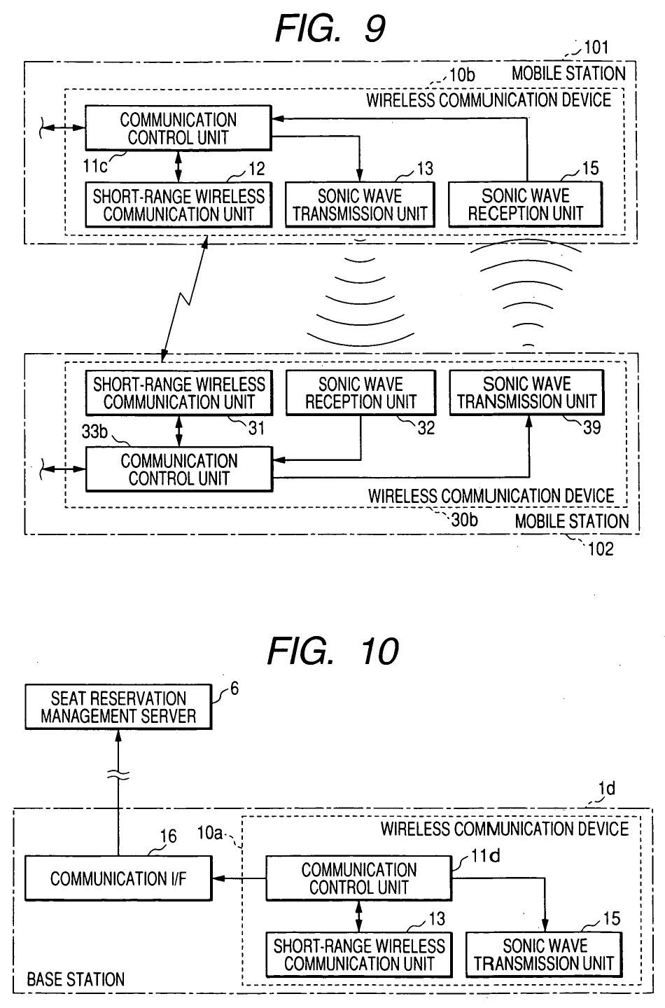

Wireless communications may be conducted between mobile stations 101 and 102, as shown in FIG. 9, as a second modified example of the embodiment. In the description with reference to FIG. 2, the sonic wave transmission unit 13 is installed in the fixed wireless communication device 10a and the sonic wave reception unit 32 is installed in the mobile wireless communication device 30a by way of example. However, when a sonic wave transmission unit 13 and a sonic wave reception unit 15 are installed in a mobile wireless communication device 10b and a sonic wave transmission unit 39 and a sonic wave reception unit 32 are installed in a mobile wireless communication device 30b as shown in FIG. 9, the mobile wireless communication device 10b and 30b can conduct communications with each other considering the distance. Further, when the sonic wave transmission unit 13, 39 transmits ultrasonic and the sonic wave reception unit 15, 32 receives ultrasonic, the mobile wireless communication device 10b and 30b can conduct communications with each other considering the direction as well as the distance. When the mobile wireless communication device 10b and 30b sets a short-range wireless communication link, either mobile wireless communication device may operate as the master.

Thus, according to the second modified example of the embodiment, data communications can be started only when the distance between the mobile wireless communication device 10b and 30b becomes a given distance. When the user arranges to meet an unknown person, when the user previously obtains the ID of the person and registers the ID and the apparatus of the user is programmed to sound a beep when the person approaches the user, the user can automatically find out the person. Further, to use the second modified example with a portable communication battle type gaming machine, etc., the user can automatically switch between a person coming in the user s presence and an opponent without need for operation of switching the opponent.

### Other Embodiments

Although the invention has been described with the specific embodiment, it is to be understood that the description and the drawings forming parts of the disclosure do not limit the invention. From the disclosure, various alternative embodiments, examples, and operational arts will be apparent to those skilled in the art.

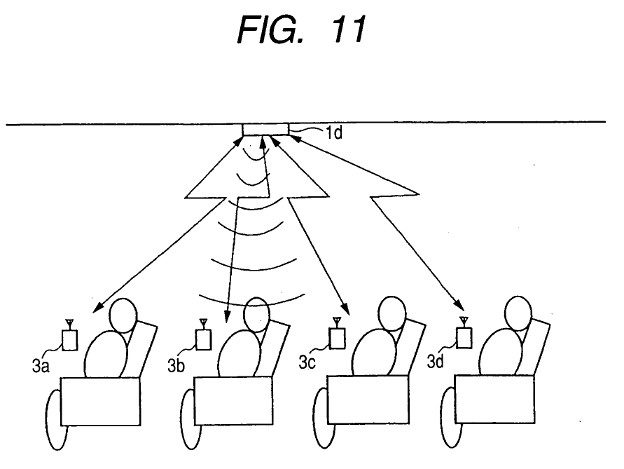

In the description of the first modified example of the embodiment given above, the invention is applied to the automatic ticket gate system by way of example, but may be applied to a seat reservation management system as shown in FIGS. 10 and 11. A base station 1d shown in FIG. 10 includes a communication interface (communication I/F) 16 in addition to a wireless communication device 1a. The communication I/F 16 is connected to a seat reservation management server 6 outside the base station 1d. To make a comparison between each seat and each user, communications can be conducted only with a mobile station positioned at a specific seat of mobile stations 3a, 3b, 3c, and 3d possessed by the users, as shown in FIG. 11. The base station 1d obtains information of electronic tickets, etc., stored in the mobile stations 3a, 3b, 3c, and 3d and sends the information to the seat reservation management server 6 through the communication I/F 16 shown in FIG. 10. A seating sensor (not shown) is installed in each seat, whereby the electronic ticket information and the sensor information are used in combination and when a user not presenting electronic ticket information exists although a person is seated, a warning is sent to the seat reservation management server 6. Consequently, the seat reservation management server 6 can make a comparison with the current reservation state.

Thus, it is to be understood that the invention contains various embodiments, etc., not described herein. Therefore, the invention is to be limited solely by the inventive concepts which are delineated by the claims adequate from the disclosure.

As described above with reference to the embodiments and examples, there is provided the wireless communication device that detects the distance from an another wireless communication device and conducts communications only with a specific communicating party within a given distance.

The foregoing description of the embodiments have been presented for purposes of illustration and description. It is not intended to be exhaustive or to limit the invention to the precise form disclosed, and modifications and variations are possible in light of the above teachings or may be acquired from practice of the invention. The embodiments are chosen and described in order to explain the principles of the invention and its practical application program to enable one skilled in the art to utilize the invention in various embodiments and with various modifications as are suited to the particular use contemplated. It is intended that the scope of the invention be defined by the claims appended hereto, and their equivalents.

What is claimed is:

1. A wireless communication device for conducting communications with an another wireless communication device, the wireless communication device comprising:
a short-range wireless communication unit that establishes a short-range wireless communication link with the another wireless communication device, and communicates data through the short-range wireless communication link;
a sonic wave transmission unit that transmits a sonic wave for detecting a position of the another wireless communication device, after the short-range wireless communication link is established; and
a communication control unit that obtains a distance to the another wireless communication device from a time period between the transmission of the sonic wave and a receipt of a reply to the transmission of the sonic wave transmitted by the another wireless communication device, and controls the short-range wireless communication unit to start communicating data when the distance is equal to or less than a predetermined value.

2. The wireless communication device according to claim 1, wherein the communication control unit comprises:
a timer that measures the time period;
a distance calculation circuit that calculates the distance based on the time period measured by the timer;
a storage device that stores the predetermined value; and
a determination circuit that determines whether or not the distance calculated by the distance calculation circuit is equal to or less than the predetermined value stored in the storage device.

3. The wireless communication device according to claim 1, wherein the sonic wave transmission unit transmits an ultrasonic wave for detecting the position of the another wireless communication device.

4. A wireless communication device for conducting communications with an another wireless communication device, the wireless communication device comprising:
a short-range wireless communication unit that establishes a short-range wireless communication link with the another wireless communication device, and communicates data through the short-range wireless communication link;
a sonic wave reception unit that receives a sonic wave transmitted by the another wireless communication device for detecting a position of the wireless communication device, after the short-range wireless communication link is established; and
a communication control unit that transmits a notification of reception of the sonic wave to the another wireless communication device through the short-range wireless communication link, and controls the short-range wireless communication unit to start communicating data when a communication start command is received from the another wireless communication device.

5. The wireless communication device according to claim 4, wherein the short-range wireless communication unit receives specification information indicating a frequency and a pulse width of the sonic wave from the another wireless communication device, before the sonic wave reception unit receives the sonic wave, and
wherein the communication control unit comprises:
a storage device that stores the specification information;
a frequency measurement circuit that measures the frequency of the sonic wave received by the sonic wave reception unit;
a pulse width measurement circuit that measures the pulse width of the sonic wave received by the sonic wave reception unit;
a determination circuit that determines whether or not the measured frequency and pulse width match the specification information stored in the storage device; and
a controller that transmits a notification of reception of the sonic wave to the another wireless communication device through the short-range wireless communication link, in accordance with the determination made by the determination circuit.

6. The wireless communication device according to claim 4, wherein the sonic wave reception unit receives an ultrasonic wave for detecting the position of the wireless communication device.

7. A wireless communication system comprising:
a first wireless communication device; and
a second wireless communication device that conducts communications between the first wireless communication device,
wherein the first wireless communication device comprises:
a first short-range wireless communication unit that establishes a short-range wireless communication link with the second wireless communication device, and communicates data through the short-range wireless communication link;
a sonic wave transmission unit that transmits a sonic wave for detecting a position of the second wireless communication device, after the first short-range wireless communication link is established; and
a first communication control unit that obtains a distance to the second wireless communication device from a time period between the transmission of the sonic wave and a receipt of a reply to the transmission of the sonic wave transmitted by the second wireless communication device, and controls the first short-range wireless communication unit to start communicating data when the distance is equal to or less than a predetermined value, and
wherein the second wireless communication device comprises:
a second short-range wireless communication unit that establishes the short-range wireless communication link with the first wireless communication device, and communicates data through the short-range wireless communication link;
a sonic wave reception unit that receives the sonic wave transmitted by the first wireless communication device for detecting a position of the wireless communication device, after the short-range wireless communication link is established; and
a second communication control unit that transmits a notification of reception of the sonic lo wave to the second wireless communication device through the second short-range wireless communication link, and controls the second short-range wireless communication unit to start communicating data when a communication start command is received from the second wireless communication device.
